(19) United States
(12) Patent Application Publication
(10) Pub. No.: US 2005/0256781 A1
(43) Pub. Date: Nov. 17, 2005

(54) System and method for communicating product information with context and proximity alerts

(75) Inventors: Ian Michael Sands, Seattle, WA (US); Victor Kevin Russ, Seattle, WA (US)

Correspondence Address: PERKINS COLE LLP/MSFT, P. O. BOX 1247, SEATTLE, WA, 98111-1247, US

(73) Assignee: Microsoft Corporation, Redmond, WA (US)

(21) Appl. No.: 11/118,117

(22) Filed: Apr. 29, 2005

Related U.S. Application Data
(63) Continuation-in-part of application No. 10/930,317, filed on Aug. 31, 2004.
(60) Provisional application No. 60/571,716, filed on May 17, 2004.

(51) Int. Cl. G06F 17/60

(52) U.S. Cl. 705/26

(57) ABSTRACT

A system and method for empowering consumers in a retail environment. Among many other features, the present invention provides timely, value-added services based on contextual information associated with a user, such as a user's location, shopping preferences, past purchasing patterns, and other information. In general, the invention provides a system that monitors the location of a wireless device. If it is determined that the wireless device is located in an area approximate to a specific region, such a store's pharmacy department, an association is made between the wireless device and a category of items, e.g., pharmaceuticals. By the use of the association, information about the category of items, or individual items, is readily available to a user of the wireless device. In addition, the present invention enables companies to provide high-quality consumer services that can differentiate between various types of consumers.

### CROSS-REFERENCE TO RELATED APPLICATIONS

This application is a continuation-in-part (CIP) patent application of U.S. patent application Ser. No. 10/930,317, filed on Aug. 31, 2004 and entitled “SYSTEM AND METHOD FOR COMMUNICATING PRODUCT INFORMATION,” which claims the benefit of U.S. Provisional Application No. 60/571,716, entitled “SYSTEM AND METHOD FOR COMMUNICATING PRODUCT INFORMATION” and filed on May 17, 2004, which is hereby incorporated by reference.

### TECHNICAL FIELD

The present invention relates to e-commerce systems, and in particular, to a method and system for enhancing the communication of retail and product information to consumers.

### BACKGROUND

In the retail industry, there is a continual need for effective and timely communication. In response to this need, there have been many improvements to the Internet and e commerce systems to better communication between retailers and consumers. While electronic commerce has improved the way consumers shop for products and services, existing systems still have many limitations. For instance, existing systems are limited to communicating specific types of information that limit consumers to certain functions, such as receiving general product information and purchasing products via a standard purchase and mail model.

In view of the above-described limitations, e-commerce systems are not generally helpful to consumers shopping in a retail store. For example, even if consumers have access to an Internet-based computer system while shopping in a store, he or she still faces the task of locating each desired product in the store. In addition, consumers may not readily have all of the product information they need at the time they need it. In some circumstances, these drawbacks, and many other limitations of the prior art systems, prevent consumers from obtaining a positive shopping experience.

As will be readily understood from the foregoing, there is a need for a system and method that improves a consumers experience while shopping in a retail store. More specifically, there exists a need for a system and method that improves communication of different types of product information.

### BRIEF DESCRIPTION OF THE DRAWINGS

Many aspects and advantages of this invention will become more readily appreciated as the same become better understood by reference to the following detailed description, when taken in conjunction with the accompanying drawings, wherein:

FIG. 1 is a simplified block diagram of a number of computers connected to a network, including a number of client computers and a server for allowing a number of users to communicate via client-server software applications;

FIG. 2 is a schematic block diagram of an exemplary embodiment of the server depicted in FIG. 1;

FIG. 3 is a schematic block diagram of an exemplary embodiment of one of the client computers depicted in FIG. 1;

FIG. 4 is a flow diagram illustrating one embodiment of a method for processing product information in accordance with the present invention;

FIG. 5 is a pictorial diagram illustrating one exemplary graphical user interface according to the present invention for displaying a list of items;

FIG. 6 is a pictorial diagram illustrating one exemplary graphical user interface according to the present invention for displaying a routing map;

FIG. 7 is a flow diagram illustrating one embodiment of a method for the location awareness feature in accordance with one embodiment of the present invention; and

FIG. 8 is a pictorial diagram illustrating exemplary graphical user interfaces that are configured for automatic updates according to the present invention for displaying a list of items.

### DETAILED DESCRIPTION

The present invention provides a number of system functions and end user features that empower consumers in a retail environment. In one aspect, the present invention provides timely, value-added services based on contextual information associated with a user, such as a user's location, shopping preferences, past purchasing patterns, and other like information. In general, the invention includes a system that monitors the location of a wireless device. If it is determined that the wireless device is located in an area approximate to a specific region, such a store's pharmacy department, an association is made between the wireless device and a category of items, e.g., pharmaceuticals.

By the use of the association, information about the category of items, or an individual item, can be readily sent to users of the wireless device. As will be described in more detail below, the information can be sent to the wireless device in a number of ways using a number of different communication mediums. For illustrative purposes, the use of the location information to associate and communicate information to consumers is referred to as the location awareness feature. In several alternative embodiments, the location awareness feature can be combined with other live communication and mapping features to enhance a consumer's shopping experience. In addition, the present invention enables companies to provide high-quality consumer services that can differentiate various types of consumers; thus, enabling companies to provide differentiating services and products.

The following description of the present invention first provides an overview of a sample system in which the present invention may be implemented. Following that, a description of a method for communicating product information on a graphical user interface shown in accompanying flow diagrams is described. In addition, the following description summarizes several methods for dynamically updating routing maps and item lists. In addition, a description of many embodiments of the location awareness feature is provided. The illustrative examples described herein are not intended to be exhaustive or to limit the invention to the precise forms disclosed. Similarly, any process steps described herein may be interchangeable with other steps, or several combinations of steps, in order to achieve the same result.

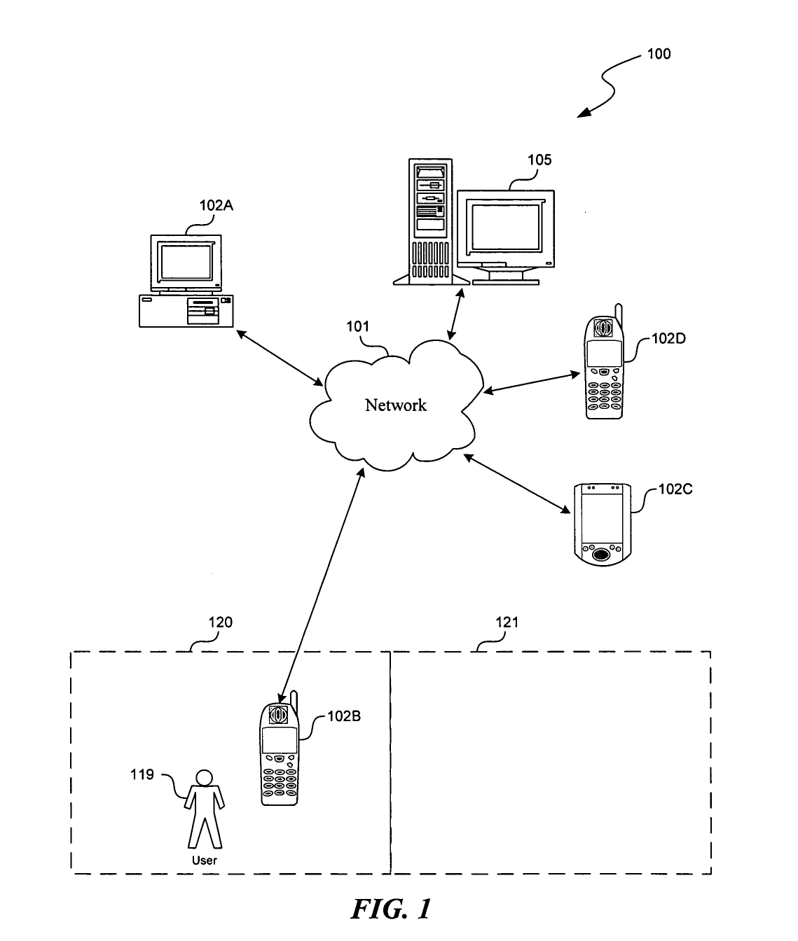

Referring to FIG. 1, the following description is intended to provide an exemplary overview of one suitable system 100 in which the invention may be implemented. The illustrated system 100 comprises a plurality of devices 102A, 102B, 102C, 102D configured to electronically communicate with a server 105 via a network 101. The devices are configured with a component for capturing an image. The server 105 may be a computer that is associated with a store that provides goods and/or services to others, whether retail, wholesale or otherwise, or any other entity that provides information about goods and services available to consumers. The network 101 may be a local area network (LAN) or a larger network, such as a wide area network (WAN) or the Internet. In FIG. 1, the devices are illustrated as computers 102A and 102C, and mobile telephones 102B and 102D. However, the devices 102A, 102B, 102C, 102D shown in FIG. 1 may take the form of any one of a number of different computer products that includes appropriate hardware and software components for running an operating system, displaying text and images, and in some cases for capturing an image. For example, the device may also be a digital camera, a two way pager, or any other wireless device. The devices may be associated with a user 119 of the system 100, such as a consumer. In the following description, mechanisms are built into each wireless device to allow location information to be communicated from each wireless device to a computing device, such as the server 105. As will be appreciated by one of ordinary skill in the art, location mechanisms, such as GPS, 802.11-based location systems and other like systems, can provide location information allowing the system 100 to determine if a user is in, near, moving towards or moving away from one or more geographical regions 120 and 121. Obviously, these devices should be considered as exemplary and not limiting. As will also be appreciated by those skilled in the art, the system 100 shown in FIG. 1 is a simplified example of one suitable system for implementing the present invention. The present invention is not limited to this type of system.

As will be described in more detail below, a consumer can use the system 100 to enter or modify a list of selected items, transmit data describing the selected items and then receive and display data that shows a location of the selected items, a route between the selected items and/or a dynamically updated list of selected items. In addition, the system 100 can be used to communicate and display any text or image of information related to the selected items. This may allow users to receive information that allows users to compare prices, read reviews about the selected items, and/or read information on related items or other suggested items.

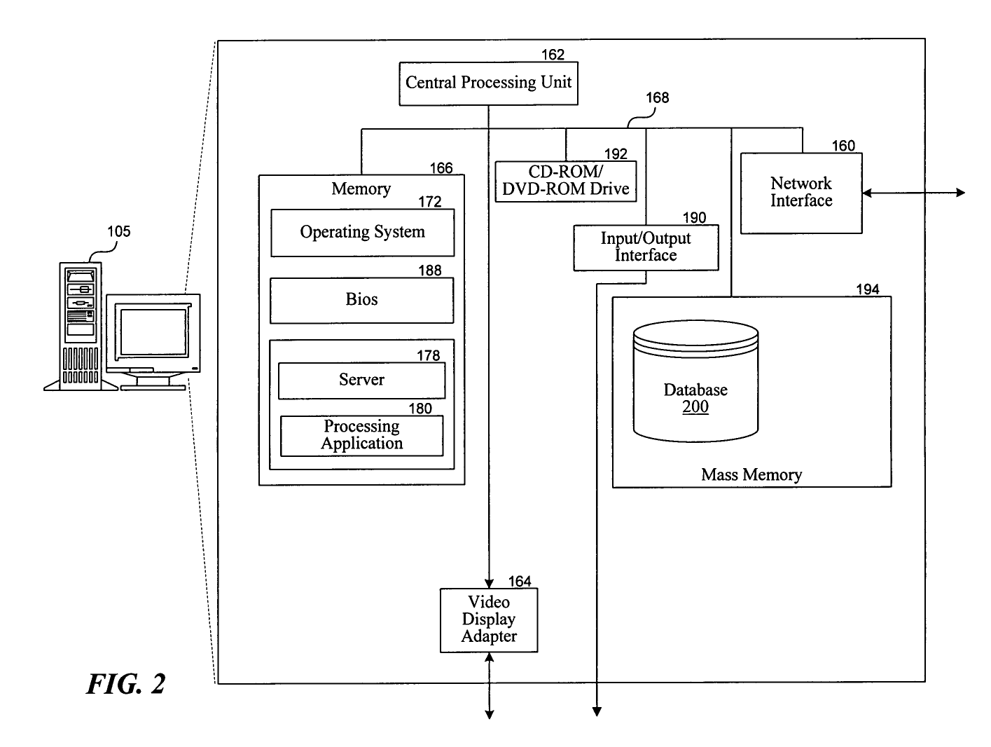

The various hardware and software components of the server 105 and the devices 102A, 102B, 102C and 102D that are used to receive, store, and process the previously described data will now be discussed in more detail. FIG. 2 depicts an exemplary computer architecture of the server 105 shown in FIG. 1. Those skilled in the art will appreciate that the server 105 may include many more or fewer components than those shown in FIG. 2. However, it is not necessary that all of these generally conventional components be shown in order to disclose an enabling embodiment of the present invention. As shown in FIG. 2, the server 105 is connected to the network 101 (FIG. 1) via a network interface 160. The network interface 160 includes the necessary hardware and software for allowing the server 105 to communicate with other computers connected to the network by the use of one or more suitable communication protocols, such as the TCP/IP protocol.

The server 105 also includes a processing unit 162, a video display adapter 164, and memory 166, all connected together and to the network interface 160 by a bus 168. The memory 166 generally comprises RAM, ROM, and permanent memory, such as a hard disk drive, tape drive, optical drive, floppy disk drive, or combination thereof. The memory 166 stores an operating system 172 for controlling the operation of the server 105. As is known to those skilled in the art, the operating system may be formed by a general purpose server operating system such as a Microsoft(r) server operating system, UNIX, or LINUX(™). A binary input/output system (“BIOS”) 188 for controlling the low-level operation of server 105 is also stored in the memory 166.

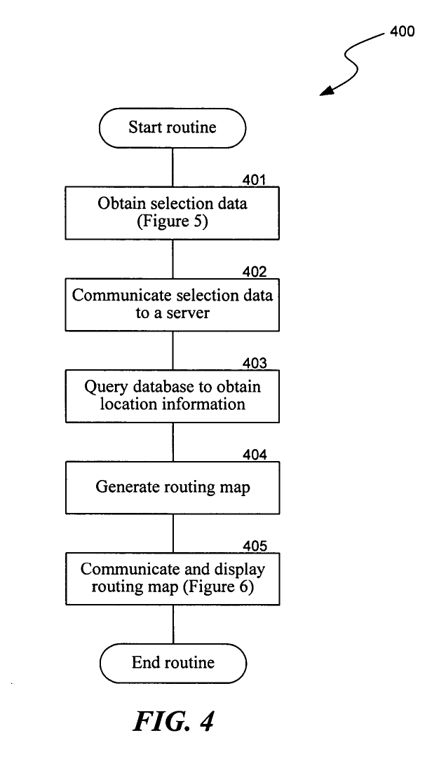

The memory 166 may also store program code and data for providing a network site that allow users to request, receive, and view information and data files stored in the server 105. Thus, the memory 166 may store a general data sharing application, such as a server application 178 that may be any one of a number of commercially available software packages. The server application 178 comprises computer executable instructions that, when executed by the server 105, communicate configurable markup documents, programs and/or scripts that produce dynamically updated displays, such as the sample displays shown in FIGS. 4-5 and 8, which are described in more detail below. The memory 166 also stores other software components, such as a processing application 180, to facilitate various functions of the present invention. As will be described in more detail below, the processing application 180 is configured to receive data from devices, query a database for item information and communicate database query results to the devices.

The server 105 may also include an input/output interface 190 connected to the bus 168 for communicating with external devices, such as a mouse, keyboard, scanner, or other input devices not shown in FIG. 2. Likewise, the server 105 may further include additional mass storage facilities, such as CD-ROM/DVD-ROM drive 192, and large capacity mass memory 194, also connected to the bus 168. The mass memory 194 may be utilized by the server 105 to store several databases. In particular, the mass memory 194 may store a database 200 for use by the processing application 180. As will be appreciated by those skilled in the art, the database 200 may be configured to contain data in any one of a number of formats suitable for storing information related to commerce items. For instance, the database 200 may be configured to store item information describing the price of an item, the availability of an item, or any other like data. In addition, the database 200 may also include medical information, consumer report information, detailed inventory information, or any other information that may help a consumer during a shopping experience. As will be appreciated by one of ordinary skill in the art, such information can be stored in the database 200 in the form of text data, audio data, video data, audio/video data, or even data that provides links to other data sources, such as a bank of URL's, phone numbers, or other like data identifiers. Such a database may also store or have access to data such as a Usenet forum, enterprise systems, other product databases and or any search engine database. Although this illustration includes examples of specific software applications and databases, this illustration should be taken as exemplary and not limiting.

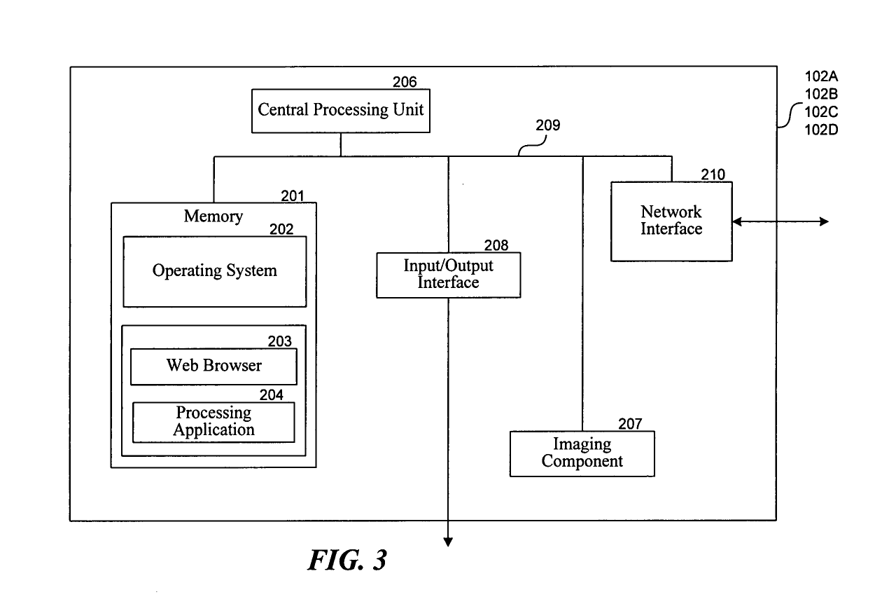

As will be appreciated by those skilled in the art, the architecture of the devices 102A, 102B, 102C, 102D may take on any suitable form, such as the architecture illustrated in FIG. 3, if appropriate. For example, a device may include a network interface 210 for providing communication with the network 101. The network interface 210 may be configured for use with any wired or wireless network connection, and may be used with any suitable communication protocol, such as the TCP/IP protocol. In general, the device includes a central processing unit 206, an input/output interface 208 and memory 201, all connected together and to the network interface 210 by a bus 209. The memory 201 stores the program code, such as an operating system 202, necessary for operating the device and for generating an interface, such as a graphical user interface (GUI) on a display of the device. In one specific embodiment, the operating system 202 may include the Microsoft Smartphone platform. The memory 201 may also store a Web browser application 203, such as Microsoft Internet Explorer(r), for browsing Web pages generated by remote servers, such as server 105.

The devices 102A, 102B, 102C, 102D may also, as an option, include an imaging component 207, such as a charge coupled device (CCD) or any other circuit suitable for capturing an image. A circuit suitable for capturing an image of an item identifier, such as barcode or text information, may be considered as a suitable imaging component 207. Portable electronics with imaging components are presently known and understood in the art of image capture and communication. The device further comprise one or more input/output devices 208, which may include a display, a speaker, or any other device for communicating information. Accordingly, the device may also contain software components, such as a processing application 204, for converting electronic signals into audible signals suitable for communicating information through a speaker.

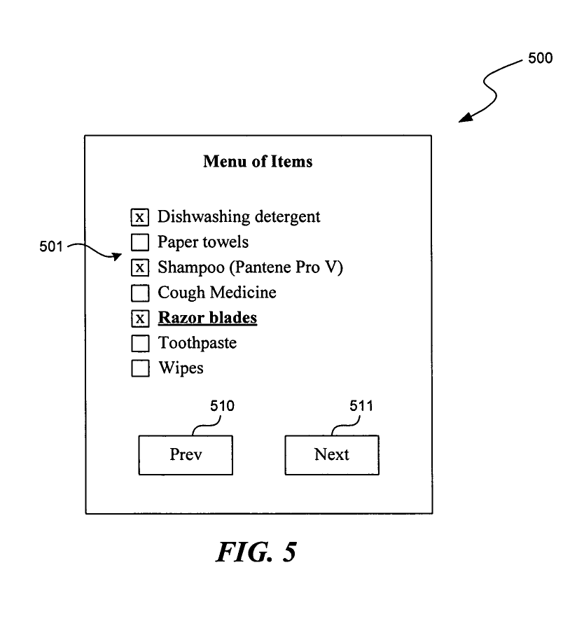

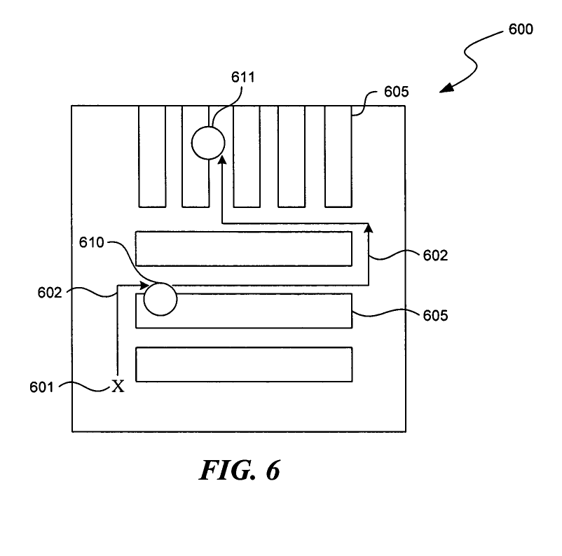

Referring now to the flow diagram of FIG. 4 and the pictorial diagrams of FIGS. 5 and 6, one sample embodiment of an information processing method 400 will now be described. In this description, the information processing method 400 communicates information related to selected items and then generates, communicates and displays a routing map that enables a user to locate the selected items. The information processing method 400 begins at block 401, where the method obtains selection data from a client device. In one embodiment, the selection data can be a list of items selected by a user, via a graphical user interface.

FIG. 5 is one example of a graphical user interface, which is referred to as an item interface 500, suitable for displaying an item list 501. As will be appreciated by one of ordinary skill in the art, the item interface 500 may be a display on any one of the devices (FIG. 1) by the use of any application, such as a Web browser or the like. In the sample shown in FIG. 5, the item list 501 lists a number of products: Dishwashing detergent, Paper towels, Shampoo (Pantene Pro V), Cough Medicine, Razor blades, Toothpaste, Wipes, etc. The item interface 500 also provides a mechanism that allows a user to select one or more of the listed items, such as a button or check box. In this example, the Dishwashing detergent, Shampoo and Razor blades are selected items.

As will be appreciated by one of ordinary skill in the art, the item list 501 may be created by the user or it may be preconfigured by a server that is configured to suggest items suitable for the user. For example, the item list 501 may be configured into an “active list,” which stores items most actively selected items. In another configuration, the item list 501 may be made from a “favorites list,” which is predetermined by a user or computer program. In yet another embodiment, the item list 501 may come from a “wish list,” “shopping cart” or any other type of user or computer configured list. Also shown, the item interface 500 may be configured with additional control mechanisms, such as a “next” button 511 and a “previous” button 510 that allows a user to access other batches of listed items.

Returning to FIG. 4, after the device obtains the selection data, the information processing method 400 continues to block 402 where the selection data is communicated to a server, e.g., server 105. In the process of block 303, depending on the type of device, the communication of the image from the device to the server may be executed by one of a number of different communication networks. In several non-limiting examples, the communication between the device and the server may include the use of a public switched telephone network (“PSTN”), wired digital data networks, such as the Internet, or a local area network (“LAN”), etc. Examples of suitable wireless communications media/methods include, but are not limited to, wireless telephony (“cellular”) including analog cellular, digital personal communications service (“PCS”), short message service (“SMS”), and wireless application protocol (“WAP”). Other suitable wireless communication media/methods include, but are not limited to, wireless digital data networks, such as 802.11 wireless LAN (“WLAN”), two-way paging networks, specialized mobile radio systems, infrared, and ISM-service communications links, such as Bluetooth. Further, some communication methods, either wired or wireless, include Internet protocol (“IP”) addressing. One skilled in the relevant art will appreciate that additional or alternative, wired or wireless, communication media/methods may be practiced and are considered within the scope of the present invention.

Once the selection data is communicated to the server 105, the method proceeds to block 403 where the selection data is used to query a database, such as the database 200 shown in FIG. 2. In one embodiment, the selection data is incorporated in a standard database query and sent to the database 200 to obtain location, price and/or other information about the selected item, which is referred to herein as “item information.” In the present example, the selection data may contain UPC data identifying the Dishwashing detergent, Shampoo and Razor blades. Those skilled in the art will recognize that virtually any type or quantity of information relating to the selected items may be obtained by the use of the above-described query. Non-limiting examples of item information that may be obtained in a database query include location, price, availability, safety or recall information, recommendations, reviews, etc.

Once the item information is obtained, the information processing method 400 proceeds to block 404, where the item information is used to generate a routing map. Generally described, a routing map may show a map of a store or map to a number of different stores. The map may also contain a graphical representation, such as a line, that shows a user of a route to follow to find each selected item. A routing map may be in the form of one of a number maps or text descriptions.

The routing map may be generated by any known pathfinding algorithms. For instance, Dijkstra's algorithm or a derivative of Dijkstra's algorithm may be used to find the shortest path between the selected items. Details of such algorithms can be found at the cites http://theory.stanford.edu/˜amitp/GameProgramming/AStarComparison.htrnl and http://www.gamasupra.com/features/20010314/pinter_{—}01.htm, the subject matter of which is specifically incorporated by reference. As also can be appreciated by those skilled in the art, modifications can be made to any algorithm so that users of the system are routed by desired locations of a retail store. For instance, the system may analyze the user's list, such as the favorites list, and then draw a route that guides the user to walk by those listed products in the store. Alternatively, or in conjunction with such a feature, the system may draw a route through designated locations to feature other items, such as a sale item in front of a store, a demo in a particular department, etc. Any routing map or pathfinding or routing algorithm may be used to implement this part of the method.

Once the routing map is generated, the information processing method 400 proceeds to block 405 where the routing map is communicated to and displayed on the device. Those skilled in the art will appreciate that any suitable communication protocol, such as those described above, may be utilized for communicating the routing map from the server 105 to the device. It is also to be appreciated that the item information retrieved by the database query (block 403) may also be communicated from the server 105 to the device.

FIG. 6 is one example of a graphical user interface displaying a sample routing map. With reference again to the above-described example, routing map may have a graphical representation of a route 602, an identifier showing a user's location 601, a map of roads or a map of a store floor layout 605 and identifiers showing the selected items 610 and 611. As will be appreciated by those skilled in the art, any general display feature can be used to enhance a users experience in viewing the routing map, such as a map zooming feature, a scrolling feature, etc. Returning to FIG. 4, after the processing of block 405, the method 400 terminates or loops through other versions of the method to dynamically update the routing map. Various embodiments of other methods for dynamically updating the routing map are described below.

In one embodiment, a routing map may be dynamically generated or updated by the use of information describing the user's location. In this embodiment, information describing the user's location may be updated by a real-time system such as a GPS system, wireless tracking system, or the like. Examples of wireless tracking systems are described in more detail in a commonly assigned patent applications: “Systems and Methods for Locating Mobile Computer Users in a Wireless Network,” filed on Jan. 12, 2001, having an application Ser. No. 09/760,180; and “Information Management and Processing in a Wireless Network,” filed on Jan. 19, 2001, having an application Ser. No. 09/766,505. The subject matter of said applications is specifically incorporated herein by reference.

Once the user's location information is obtained by the system or the device, the system can update the route on the map to show the user's location relative to other selected items. In addition, an updated map may identify a product that is close to the user's location, pop-up an ad related to the product, play a video feed providing information related to the product, or perform a number of other functions. In another example, the system can examine the user's favorite list or any other list stored on the user's device, and then generate a signal to let the user know that he or she is located near an item on one or more of the stored lists. In yet another example, the user may randomly select a particular item on a list and command his or her device to draw a direct route to the particular item. These embodiments may utilize the above mentioned database, pathfinding algorithms and user location mechanisms. In summary, the system is capable of providing any type of information, in any format, regarding a product that is close to the user.

In addition to displaying a routing map or text describing a route between items, the system can be configured to display other types of information for enhancing a shopper's experience. For example, among other types of information, the system may display inventory information, price information, comparison price information, customer review information, discount information, cross-sale information, cross-promotion information or any other type of information related to an item. In other examples, the system may display gift suggestions or other suggestions that are based on the users past shopping patterns. The system may obtain such information in a database query such as the database query described above. In addition to, or as an alternative to, displaying the routing map and/or other item information, the communicated information can be converted to a signal suitable for audibly communicating the information to the user.

In a specific example, the system may be configured to determine if a user is standing near, i.e., within a few feet, a particular item, such as cough medicine. By obtaining the user's location information from the device, and other data describing the location of the cough medicine, the system can automatically communicate information related to cough medicine, e.g., a pharmacist's suggestion related to the cough medicine or the like. This communicated information may be in the form of text or a video/audio feed. Alternatively, or in addition to providing the audio/feed, the system may provide contact information for a category/product specialist or another business entity.

In another embodiment, the system utilizes a user's location information to dynamically update a list of items, such as a favorites list. In one implementation, the system determines if a user is near or in a particular store. Once it is determined that the user is near or located in the store, the system will query the store's database to determine if the items have a certain status, e.g., the items are in are in stock. The system may then alert the user of item level status suggesting alternative items from the store's database if user preferred items are not in stock. The system may also highlight items that are in stock. In other embodiments, user lists may be updated in response to one or more user actions. For example, items on a shopping list or favorites list may be removed or checked off as the user places the items in a virtual shopping basket. In another example, the system highlights or updates particular items on a list when the user comes within a predetermined distance from the particular item.

In yet another example of an embodiment having a dynamically updated list, the system reorders a list of items depending on the status of each item. In such an embodiment, the system may determine the location of the user and the location of each listed item and then reorder the user's list depending on the distance between the user and each item. In other examples, a list of items may be reordered or sorted if the system determines that certain items are in stock or if the system determines if items are marked with a certain status, i.e., that a particular item is on sale or marked for promotion. The status of each item may be retrieved from an item database such as the database 200 shown in FIG. 2.

In addition to providing dynamically updated lists, the system may display price totals and price savings information to users. In such an embodiment, the system may also provide an automatic checkout system that allows users to add items to a virtual shopping cart and then execute a transaction to purchase the selected items. Among other features, the system can update a price total by adding a price of a particular item as the user adds the particular item to a virtual shopping cart. It will be appreciated that the price of a particular item may be added to a price total in response to other types of actions. For instance, the price of a particular item may be added to a running total when the user picks up the particular item. In combination with all or some of the above-mentioned features, the system can provide all of the necessary hardware and software components to facilitate a purchase of the select items via the device, including transactional software that permits a monetary or credit transfer from the user to any other user, store or entity selling products or services. In such an embodiment, a transaction may be executed in response to a number of actions. For instance, a transaction may be initiated by the user or it may be automatically executed when the user walks through the door of a store or through another designated location.

In another embodiment, which can be used in conjunction with or separate from the above-described embodiments, a device of the system (100 of FIG. 1) can be used to collect data by the use of a camera or other imaging component, and request information that is related to an item. For example, one may use the camera of a mobile phone to capture an image of a barcode associated with an item. By use of the processor of the device or by the processor of a server, the captured image is converted to an item identifier, such as a bar code or UPC. The item identifier is then used to query a database, such as database 200, to obtain information related to the item, such as information describing the item's location, price, user review, newsgroups, web logs, etc. Embodiments of the present invention may also utilize other systems for obtaining information. For instance, embodiments of the present invention may use systems and methods disclosed in a commonly assigned patent application: “Wireless Programmable User Interaction System With Machine-Readable Tags For Physical Objects,” filed on Jun. 27, 2003, having an application Ser. No. 10/608,240. The subject matter of said application is specifically incorporated herein by reference. The obtained information, such as the obtained product information described above, is then communicated back to the mobile phone and displayed or played back to a user via a text, GUI, video or audio feed.

In an example system and method of the image processing embodiment, the image may include any type of image format suitable to communicate a bar code, a text message, or even the general shape of an item. Once the captured image stored in the device, the image data is then communicated to the server 105 by the use of any available communications mechanism, such as those described above. After the image data is communicated to the server, or in some embodiments, prior to the communication to the server, the image data is converted into a code that identifies the product. For example, an image to text conversion may take place on the device or on the server 105. To implement this step, any one of a number of existing programs may be used, such as an optical character recognition (OCR) program or a barcode interpreting program. Once the image is converted to a product identifying code, such as UPC, the code is used to query for information related to the product. Product information is retrieved from one or more sources, such as an on-line service, and then communicated back to the device. Retrieved product information can include, but is not limited to, video and/or audio feeds describing a product, information or images from a Usenet forum, inventory information, etc.

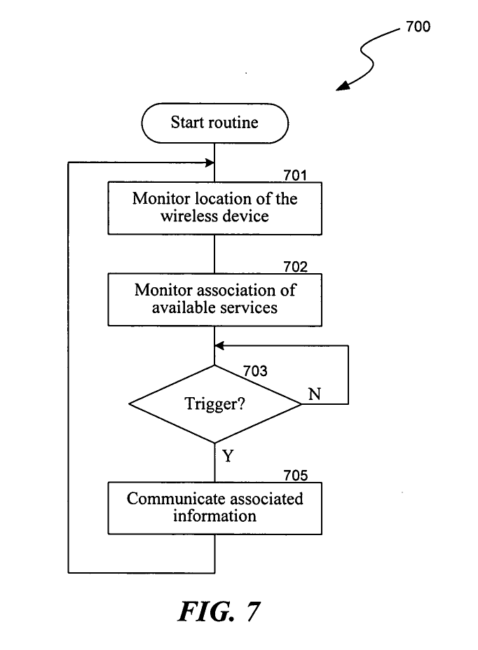

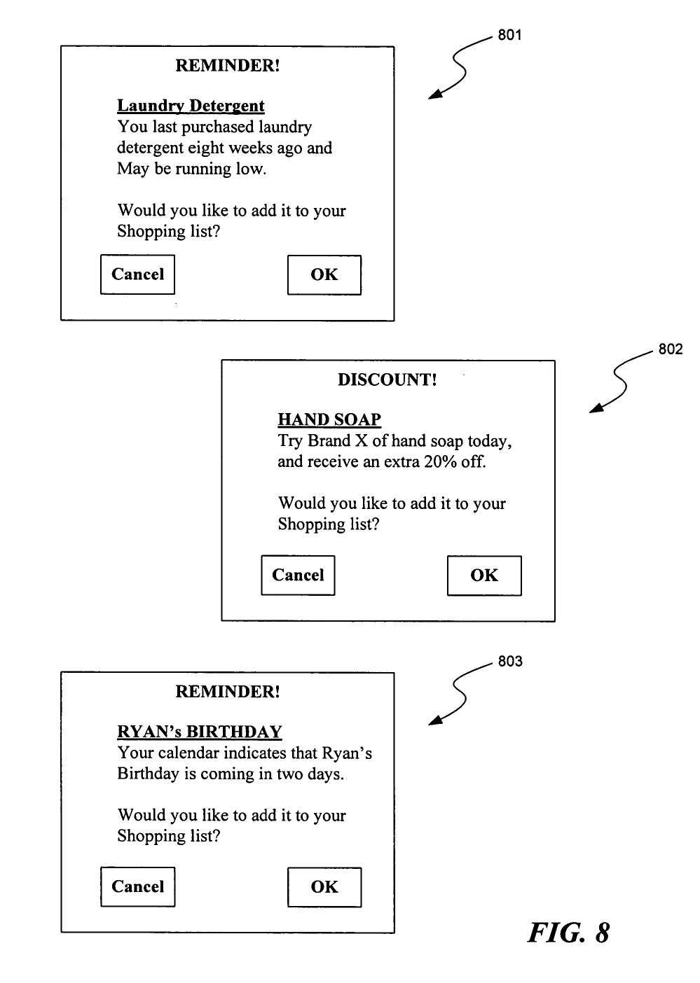

Referring now to FIGS. 7 and 8, aspects of the location awareness features are now described. A non-limiting example involving a customer's store shopping experience will be used to describe the location awareness features. In this example, the customer's personal information is logged in the store's database as a “preferred” customer. By joining the store's program they have allowed their wireless device, such as a mobile phone to be recognized by the store's wireless network. In return, as described below, the customer receives a number of high-value services provided by the system of the present invention.

Upon entering the store, using the above-described features, the customer's shopping list is matched in real-time against the store's database of in-stock items and mapped for the user, showing physical location of those items. As the customer moves through the store they can activate the location awareness feature, thereby allowing the store to know of their location as they move about the store. Knowing the location of the customer allows the store's system provides highly relevant contextual alerts, targeted discounts, and assistance. For example, while the customer walks down an aisle towards their next purchase, it just so happens that the aisle they are in contains laundry detergent. Since the system and the database provide a history of the customers purchasing patterns, the system recognizes that this customer typically buys laundry detergent every 8 weeks. If it has been more that 8 weeks since the last purchase of that particular item, the system generates a signal to provide the customer with a friendly reminder that they may need laundry detergent, just as they pass by their favorite brand. As a result the store and the consumer both receive substantial benefit from the system.

FIG. 7 illustrates a flow diagram of one embodiment of a communication method 700. Generally described, the communication method 700 monitors the location of a wireless device and then creates an association between the wireless device and specific product information, so when there is a request or trigger to communicate the information, the system 100 can readily deliver information that is more relevant to the user's immediate interests.

The communication method 700 begins at block 701, where the system monitors the location of a wireless device. As described above with respect to FIG. 4, the location of a wireless device may be monitored by the use of a number of mechanisms, such as a GPS system, 802.11-based wireless tracking system, or any other suitable system. The data indicating the location of the wireless device may be communicated to a computer, such as the server 105.

By using the location data produced by process block 701, the process of block 702 monitors and continually compares the location data with stored data so the system can associate the wireless device with one or more available services. Generally described, in this part of the process, the system monitors the location data received from the wireless device to determine if the wireless device is moving towards, close to, located in or has moved to a predefined geographical region. For illustrative purposes, the system may store data that defines predefined geographical regions, each of which may be associated with one or more particular services or categories of commerce items. In several examples, a predefined geographical region may be a store's particular department, aisle, section or any other physical zone of interest.

In one implementation, the system database stores information that associates each predefined geographical region with a particular service, category of products, a particular product, or any other user-specified commerce item. Thus, when the system determines that the wireless device has moved into a predefined geographical region, the wireless device can be associated with a particular service, category of products, a particular product, or any other user-specified commerce item. In the present example, with reference to FIG. 1, if the user is located in a first region 120, and the first region is associated with the pharmaceutical department, the system associates the wireless device 102B with information about products or services in the pharmaceutical department. By the use of the association between the wireless device and the specific products or services, more relevant information readily available to the user of the wireless device.

As noted above, the associated information may include medical information, consumer report information, detailed inventory information, or any other information that may help a consumer enhance a shopping experience. As will be appreciated by one of ordinary skill in the art, such information can be stored in a database in the form of text data, audio data, video data, audio/video data, or even data that provides links to other data sources, such as a bank of URL's, phone numbers, or other like data identifiers.

As will be appreciated by one of ordinary skill in the art, the server may optionally contain a member's list that ranks the priority of services to each customer/user. Thus, if a category of users is deemed to be a higher priority, e.g., a preferred customer, the system may provide more desirable information or features for that category of users. In one embodiment, the system provides this differentiating service by comparing the categories of users with one or more unique identifiers provided by each wireless device. If at least one unique identifier of a wireless device is associated with a high priority customer group, the system may provide preferred or special services for the user of the wireless device. As a result, the differentiating services allow a store to allocate and share its customer service resources more efficiently.

In alternative embodiments, the association made in process block 702 may be based on one or more user-defined conditions. For example, the association between a wireless device and a particular service or category of items may be made if the user is in a predefined geographical region, or moving towards or away from a predefined geographical region. In other alternative embodiments, an association can be made if a wireless device remains in a predefined geographical region for a set period of time. As will be appreciated by one of ordinary skill in the art, a combination of these and/or other conditions may be the base condition for each association made in process block 702.

Referring now to block 703 of FIG. 7, while the system monitors the association of available services, the system also awaits for one or more triggers. As will be described in more detail below, a trigger may be proactive, reactive or involve both proactive and reactive elements. A proactive trigger is initiated by the system, such as a server computer, and it can depend on one or more user-defined conditions. In one example, the server may initiate a proactive trigger if it determines that a user is located near a department of interest. A reactive trigger may be initiated by the wireless device and it can be initiated by an action of the user, e.g., the user pressing a button indicating a request for services. A reactive trigger may be initiated by the wireless device and it can also depend on one or more user-defined conditions.

In one illustrative example of a proactive trigger, the system may initiate a trigger if it is determined that the wireless device (the user) is located near a particular item and if the particular item is of interest. As noted in the above-described scenario, an item of interest may be one that is on a customer's shopping list, shopping history, or any other user-configured list.

When a trigger is initiated, the communication method 700 proceeds to block 705 where the system communicates the associated information to the wireless device. In this example, in block 705, the system may communicate data to automatically bring attention to the item on the user's shopping list. As shown in FIG. 5, the user interface of the wireless device may highlight one item (the Razor Blades) on the list. Alternatively, or in addition to bringing focus to an item on a list, other alarms or signals may be generated from to bring more attention to the communication of block 705. After the process of block 705, the communication method 700 returns to block 701 where the system continues to monitor the user's location and shopping preferences. Although the above-described example uses a shopping list and shopping history, any user-configured list may be used to associate the user's selected items with the user's location. For example, a user-configured list may be a favorites list, wish list, gift list, etc.

Other examples of alerts produced by the process of block 705 are shown in FIG. 8. The first example window 801 displays a notice that states, “You last purchased laundry detergent eight weeks ago and may be running low.” The phone also provides, as an optional feature, other functionality that allows a user to add that item to their shopping list. To facilitate this functionality, the system communicates product data about the item to the wireless device. This allows the wireless device to add the product information to their shopping list. The product information may include any relevant information, such as the brand name, the location of the product, or any other like information. Thus, as another optional feature, the phone may then display a map showing the location of the product.

In another example, shown in the second example window 802, the user's wireless device states, “Try Brand X of hand soap today, and receive an extra 20% off.” This type of notice is provided if the user is located near a product that is on sale. To facilitate this functionality, the system may flag a number of items as having a special status. When the user is located near the item, or going toward the item, or even leaving the store, etc., the product data about the item is communicated to the wireless device. Using software on the phone, this communicated information allows the wireless device to add the product information to their shopping list. Similar to the above-described example, the communicated information may include any relevant information, such as the brand name, the location of the product, or any other like information.

In yet another example, shown in the third example window 803, the user's wireless device states, “your calendar indicates that Ryan's Birthday is coming in two days.” This type of notice is provided if the user is located near a product or department that is of interest to the user. To facilitate this functionality, the system may check the user's calendar or task list to determine if there is any reference to an item or category of items of interest. If the item or category of items of interest coincide with or relate to any products or category of products in the store's database, a trigger may be initiated, and in turn, the system may send a message shown in the third example window 803. This may occur when the user is located near an item, or going toward an item, or even leaving the store, etc. Similar to the above-described examples, the communicated information may include any relevant information, such as the brand name, the location of the product, or any other like information.

Returning to the flow diagram of FIG. 7, after the associated information is communicated to the wireless device (process block 705), the communication method 700 returns to block 701 where the system repeats the above-described process and continues to monitor the location and associated information. If the wireless device transfers from one region to another, e.g., to another store, another department within a store or another type of predefined geographical region, the system associates the wireless device with other types of information based on the location of the wireless device. This movement may initiate a trigger causing the system to send a notice, announcement, or update the user's shopping list, etc. Such features provide value-added services based on contextual information associated with a user, such as a user's location, shopping preferences, past purchasing patterns, and other information.

In addressing the ‘help’ problem outline above, the present invention provides a user experience scenario in the aforementioned embodiments that explores the concept of proximity sensitive assistance, which can be delivered as part of a smart phone shopping application. At a high level, the solution allows retailers to provide, among many other benefits, better assistance to their customers, enhance employee efficiencies, and reduce employee training time.

While the foregoing description makes reference to preferred embodiments, the scope of the invention is defined solely by the claims that follow and the elements recited therein. Thus, the non-limiting examples

1. A method for communicating information associated with commerce items to a user of a wireless device, the method comprising:
monitoring the location of the wireless device to determine if the wireless device is located in an area approximate to a predefined geographical region;
associating the wireless device with a category of information, wherein the association is made if the wireless device is located in an area approximate to the predefined geographical region related to the category of information;
obtaining a trigger to initiate the communication of associated information to the wireless device;
communicating the associated information to the wireless device in response to obtaining the trigger.

2. The method of claim 1, wherein the method further comprises, dynamically associating the wireless device with a second category of commerce items if it is determined that the wireless device has moved to a second predefined geographical region related to the second category of commerce items.

3. The method of claim 1, wherein trigger is generated from a server computer of the system, and wherein the server computer generates the trigger when the server computer determines that the location of the wireless device is in proximity to a specific commerce item.

4. The method of claim 3, wherein the specific commerce item is stored on a user-configured list, thereby allowing the server computer to automatically communicate updated information associated with the specific commerce item on the user-configured list when the wireless device is in proximity to the specific commerce item.

5. The method of claim 1, wherein trigger is generated when it is determined that the wireless device is moving towards the predefined geographical region.

6. The method of claim 1, wherein trigger is generated when it is determined that the wireless device has been located in the predefined geographical region for a particular time period.

7. The method of claim 1, wherein communicating associated information includes the communication of data suitable for modifying a graphical display of the wireless device.

8. The method of claim 1, wherein communicating associated information includes communication of video and audio data between the system and the wireless device.

9. The method of claim 1, wherein communicating associated information includes communication of text messages and graphical information from the system to the wireless device.

10. The method of claim 1, wherein trigger is generated when it is determined that the location of the wireless device is in proximity to a specific commerce item and the specific commerce item is referenced a stored calendar of events.

11. The method of claim 1, wherein trigger is generated when it is determined that the location of the wireless device is in proximity to a specific commerce item and the specific commerce item is referenced a stored shopping history list.

12. The method of claim 1, wherein trigger is generated when it is determined that the location of the wireless device is in proximity to a specific commerce item and the specific commerce item is referenced a stored favorites list.

13. A computer-readable medium containing computer-readable instructions which, when executed by a computer, performs the method of claim 1.

14. A computer-controlled system for performing the method of claim 1.

15. A method for communicating information of commerce items, the method comprising:
obtaining data identifying a plurality of selected items, wherein the data is obtained from a wireless device;
obtaining location information associated with the plurality of selected items;
monitoring the location of the wireless device;
associating the wireless device with the plurality of selected items, wherein the association is made if the wireless device is located in approximate to a predefined geographical region related to the plurality of selected items;
generating data suitable for updating a user interface on the wireless device, wherein the data includes information related to the plurality of selected items; and
communicating the data to the wireless device for updating the display of one or more user interfaces.

16. The method of claim 15, wherein the method further comprises:
obtaining price information associated with the plurality of selected items; and
including the price information in the data communicated to the wireless device.

17. The method of claim 15, wherein the method further comprises:
obtaining inventory information associated with the plurality of selected items; and
including the inventory information in the data communicated to the wireless device.

18. The method of claim 15, wherein the data identifying a plurality of selected items is generated from a user-configured favorites list, and wherein the method further comprises, dynamically updating information describing an individual item on the user-configured favorites list based on the inventory information.

19. A computer-readable medium containing computer-readable instructions which, when executed by a computer, performs the method of claim 15.

20. A computer-controlled system for performing the method of claim 15.
